(19) United States
(12) Patent Application Publication
(10) Pub. No.: US 2013/0150094 A1
(43) Pub. Date: Jun. 13, 2013

(54) SERVER AND MONITORING METHOD THEREOF

(71) Applicant: FENG-CHI YANG, Tu-Cheng (TW)

(72) Inventor: FENG-CHI YANG, Tu-Cheng (TW)

(73) Assignee: HON HAI PRECISION INDUSTRY CO., LTD., Tu-Cheng (TW)

(21) Appl. No.: 13/421,882

(22) Filed: Mar. 16, 2012

(30) Foreign Application Priority Data
Dec. 12, 2011 (CN) 201110412241.3

(51) Int. Cl. H04W 4/14; H04W 68/00

(52) U.S. Cl. 455/458; 455/466

(57) ABSTRACT

A server and a monitoring method for the server is presented. The server communicates with a mobile device via wireless and includes an intelligent platform management interface (IPMI) architecture to monitor all aspects of the running of the server in real time. The method includes steps of: acquiring running information of the server when the IPMI architecture detects that an abnormal operation condition the server has been detected or the time duration of a monitoring cycle has elapsed; converting the acquired information into a format suitable for the SMS and generating an SMS message containing the running information of the server; and outputting the SMS message and sending the SMS message to the mobile device.

### BACKGROUND

1. Technical Field

The disclosure relates to servers and, more particularly, to a server and a monitoring method in relation to the server.

2. Description of Related Art

A server may perform large-scale data processing. An administrator may work beside the server to monitor the running of the server all the time, or remotely monitor the running of the server via a network, to be assured of the normal running of the server. However, the administrator must use his own time to initiate and carry out an examination of the running of the server, thereby wasting a lot of time of the administrator.

Therefore, what is needed is a server to overcome the described shortcoming.

### BRIEF DESCRIPTION OF THE DRAWINGS

FIG. 1 is a schematic view of a server communicating with a mobile device to enable monitoring in accordance with an exemplary embodiment.

FIG. 2 is a block diagram of the server of FIG. 1.

FIG. 3 is a block diagram of a control unit of the server of FIG. 1.

FIGS. 4-6 contain a flowchart of a monitoring method applied to the server of FIG. 2.

### DETAILED DESCRIPTION

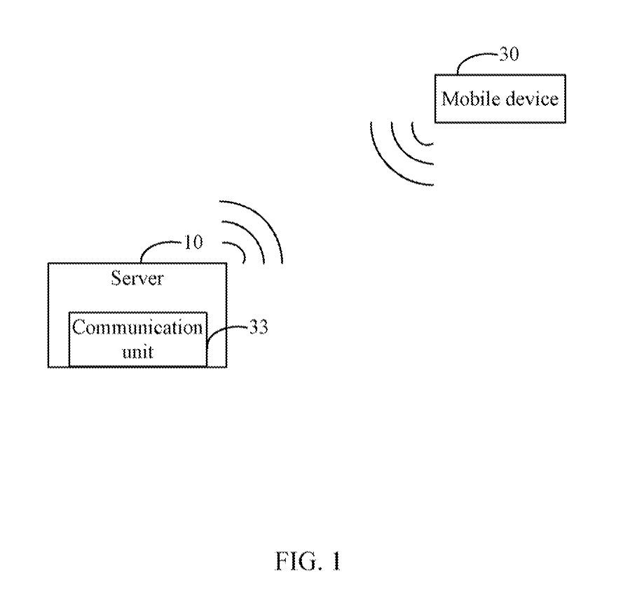

FIG. 1 is a schematic view of a server communicating with a mobile device to enable monitoring in accordance with an exemplary embodiment. The server 10 communicates with the mobile device 30 via a wireless communication system (not shown). For example, the mobile device 30 may be a mobile phone. An administrator of the server 10 can carry the mobile device 30.

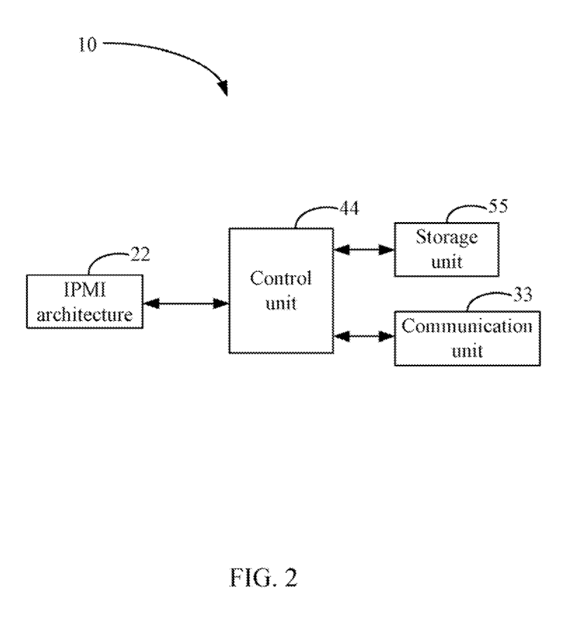

FIG. 2 is a block diagram of the server of FIG. 1. The server 10 includes an intelligent platform management interface (IPMI) architecture 22, a communication unit 33, a control unit 44, and a storage unit 55. The IPMI architecture 22 monitors aspects of the running of the server 10 in real time. The control unit 44 is electrically connected with the IPMI architecture 22 and controls communication between the server 10 and the mobile device 30. The communication unit 33 sends signals to the mobile device 30 and receives signals from the mobile device 30. The storage unit 55 stores information, such as running information of the server 10, and a monitoring cycle, such as every two hours.

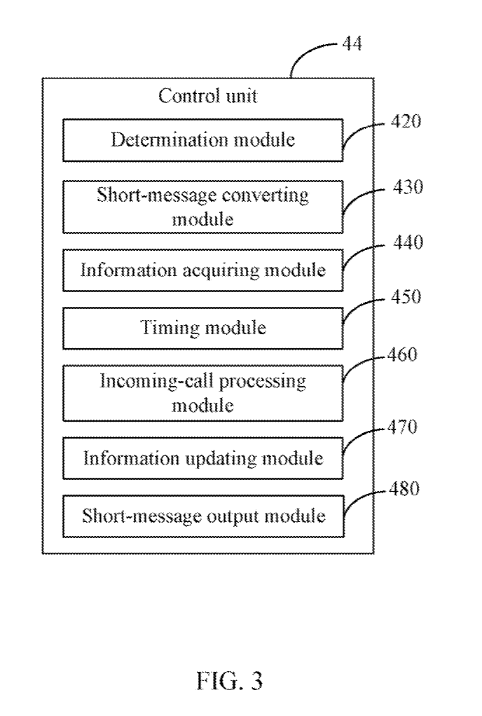

As shown in FIG. 3, the control unit 44 includes a determination module 420, a short-message converting module 430, an information acquiring module 440, a timing module 450, an incoming-call processing module 460, an information updating module 470, and a short-message output module 480.

The determination module 420 waits for an indication from the IPMI architecture 22 that an abnormal operation condition in the server 10 has been detected. When the IPMI architecture 22 detects that the server 10 has an abnormal operation condition, the information acquiring module 440 acquires information as to the abnormal operation condition of the server 10. For example, an abnormal operation condition may include a too-high temperature of a CPU of the server 10. Such information belongs to the running information of the server 10. The short-message converting module 430 converts the acquired information as to the abnormality into a format suitable for short message service (SMS) and generates an SMS message containing the acquired information. The short-message output module 480 outputs the SMS message from the short-message converting module 430 and controls the communication unit 33 to send the SMS message to the mobile device 30. For example, the communication unit 33 may send an SMS message stating “too-high temperature of CPU” to the mobile device 30, thus the administrator of the server 10, or the carrier of the mobile device 30, can without any delay receive information as to an abnormality of the server 10, to be assured of a normal running of the server 10.

The timing module 450 measures time. When an elapsed time of the timing module 450 reaches the monitoring cycle, the information acquiring module 440 acquires current running information of the server 10 even if no abnormality has been detected or reported.

In another embodiment, the information acquiring module 440 acquires current running information of the server 10 in response to a command signal from the mobile device 30. The short-message converting module 430 converts the current running information of the server 10 into the format suitable for the SMS and generates an SMS message containing the current running information. The short-message output module 480 outputs the SMS message from the short-message converting module 430 and controls the communication unit 33 to send the SMS message to the mobile device 30. Therefore, the administrator of the server 10 can know the running situation of server 10 at the end of each monitoring cycle in any event, or at any time whenever the current running information of the server 10 is required. For example, the mobile device 30 may receive an SMS message from the server 10 and the contents of the SMS message include a first running parameter xxx and a second running parameter xxx between 8 am and 10 am on Jan. 1, 2012.

The determination module 420 is able to determine the receipt by the communication unit 33 of any incoming-call signal from the mobile device 30. When the determination module 420 has determined the receipt of an incoming-call signal from the mobile device 30, the incoming-call processing module 460 recognizes contents of the incoming call and generates a request instruction in relation to the contents of the incoming call. That means that the request instruction reflects the needs of the administrator of the server 10. The information updating module 470 controls the IPMI architecture 22 to execute the request instruction and update corresponding configurations of the server 10 according to the contents of the incoming call. For example, the contents of the incoming call are about turning up the rotation speed of fans, and the information updating module 470 turns up the rotation speed of fans. Therefore, the administrator of the server 10 can remotely control the running of the server 10 by the mobile device 30, thereby ensuring the continued normal running of the server 10.

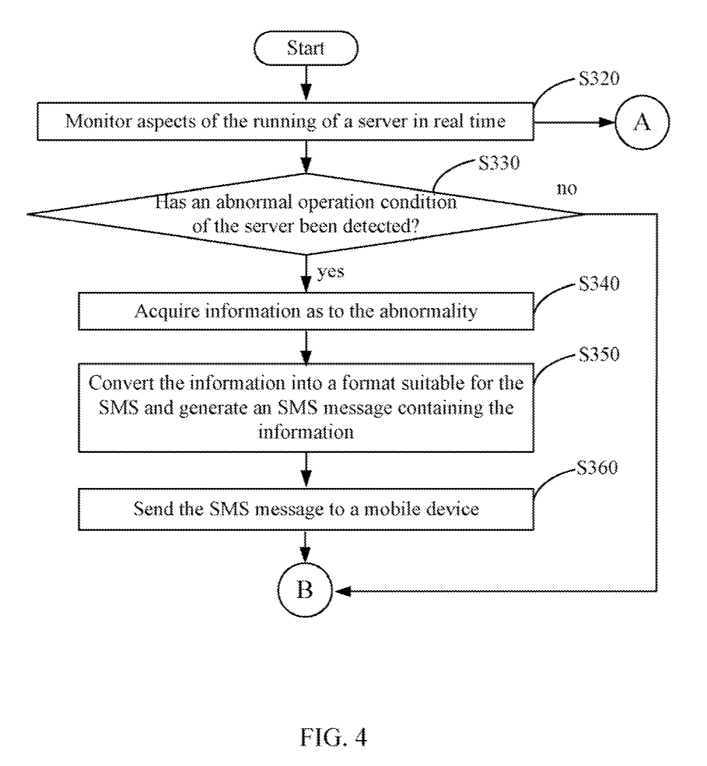

FIGS. 4-6 contain a flowchart of a monitoring method adapted for the server of FIG. 2. Referring to FIG. 4, in step S320, the IPMI architecture 22 monitors aspects of the running of the server 10 in real time. In step S330, the determination module 420 becomes aware that the IPMI architecture 22 has detected an abnormal operation condition of the server 10. In step S340, if the IPMI architecture 22 has detected an abnormal operation condition of the server 10, the information acquiring module 440 acquires information of the server 10 as to the abnormality. In step S350, the short-message converting module 430 converts the information regarding the abnormality into a format suitable for the SMS and generates an SMS message containing the information of the server 10. In step S360, the short-message output module 470 outputs the SMS message from the short-message converting module 430 and controls the communication unit 33 to send the SMS message to the mobile device 30.

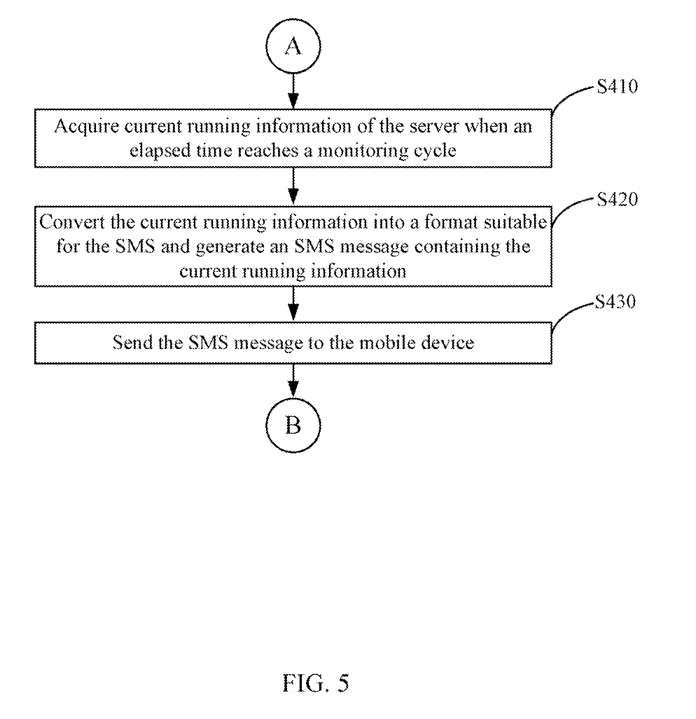

Referring to FIG. 5, in step S410, the timing module 450 counts the passing of time, and when an elapsed time of the timing module 450 reaches the monitoring cycle, the information acquiring module 440 acquires current running information of the server 10. In step S420, the short-message converting module 430 converts the current information into a format suitable for the SMS and generates an SMS message containing the current running information of the server 10. In step S430, the short-message output module 470 outputs the SMS message from the short-message converting module 430 and controls the communication unit 33 to send the SMS message to the mobile device 30.

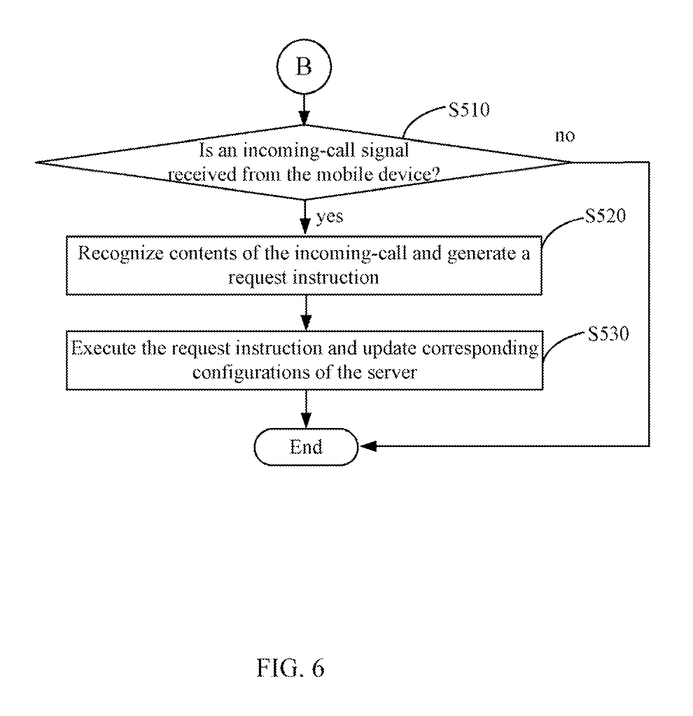

Referring to FIG. 6, in step S510, the determination module 420 determines the receipt of an incoming-call signal from the mobile device 30 by the communication unit 33. In step S520, when the determination module 420 has made such a determination, the incoming-call processing module 460 recognizes contents of the incoming call and generates a request instruction in relation to the contents of the incoming call. In step S530, the information updating module 470 controls the IPMI architecture 22 to execute the request instruction and update corresponding configuration of the server 10 according to the request instruction, and the procedure ends.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A server comprising:
an intelligent platform management interface (IPMI) architecture to monitor aspects of the running of the server in real time;
a communication unit to communicate with a mobile device via a wireless network; and
a control unit comprising:
a timing module to measure time;
an information acquiring module to acquire running information of the server when the IPMI architecture detects that an abnormal operation condition of the server has been detected or an elapsed time of the timing module reaches a monitoring cycle;
a short-message converting module to convert the acquired running information into a format suitable for short message service (SMS) and generate an SMS message containing the acquired running information; and
a short-message output module to output the SMS message from the short-message converting module and control the communication unit to send the SMS message to the mobile device.

2. The server as recited in claim 1, further comprising:
a determination module to determine whether the communication unit receives an incoming-call signal from the mobile device;
an incoming-call processing module to recognize contents of the incoming call and generate a request instruction in relation to the contents of the incoming call when the determination module determines that the communication unit receives the incoming-call signal from the mobile device; and
an information updating module to control the IPMI architecture to execute the request instruction and update corresponding configurations of the server according to the request instruction.

3. The server as recited in claim 1, wherein the information acquiring module is configured to acquire running information of the server in response to a command signal from the mobile device.

4. A monitoring method for a server, wherein the server communicates with a mobile device via wireless and comprises an intelligent platform management interface (IPMI) architecture to monitor aspects of the running of the server in real time, the method comprising:
acquiring running information of the server when the IPMI architecture detects that an abnormal operation condition of the server has been detected or an elapsed time reaches a monitoring cycle;
converting the acquired running information into a format suitable for short message service (SMS) and generating an SMS message containing the acquired running information of the server; and
outputting the SMS message and sending the SMS message to the mobile device.

5. The monitoring method for a server as recited in claim 4, further comprising:
determining whether an incoming-call signal from the mobile device is received;
recognizing contents of the incoming call and generating a request instruction in relation to the contents of the incoming call when the incoming-call signal from the mobile device is received; and
controlling the IPMI architecture to execute the request instruction and update corresponding configurations of the server in response to the request instruction.

6. The monitoring method for a server as recited in claim 4, further comprising:
acquiring running information of the server in response to a command signal from the mobile device.
